(19) United States
(12) Patent Application Publication
(10) Pub. No.: US 2024/0083076 A1
(43) Pub. Date: Mar. 14, 2024

(54) Injection Mold Insert and Method of Manufacturing the Same

(71) Applicants: Tyco Electronics Singapore Pte. Ltd., Singapore (SG); Tyco Electronics (Shanghai) Co., Ltd., Shanghai (CN)

(72) Inventors: Hengky Eng, Singapore (SG); Kim Hai Wong, Singapore (SG); Zhongxi Huang, Shanghai (CN)

(73) Assignees: Tyco Electronics Singapore Pte. Ltd., Singapore (SG); Tyco Electronics (Shanghai) Co., Ltd., Shanghai (CN)

(21) Appl. No.: 18/466,361

(22) Filed: Sep. 13, 2023

(30) Foreign Application Priority Data
Sep. 13, 2022 (CN) 202211110533.6

(51) Int. Cl. B29C 33/38; B29C 45/26

(52) U.S. Cl. CPC B29C 33/3828; B29C 33/3842; B29C 45/26; H01R 43/18

(57) ABSTRACT

An injection mold insert includes a first metal structure and a second metal structure. The first metal structure has a first hardness and a first thermal conductivity. The second metal structure is wrapped in the first metal structure and has a second hardness less than that of the first hardness, and a second thermal conductivity higher than the first thermal conductivity. The first metal structure and the second metal structure are sintered together without layering or infiltration.

### CROSS-REFERENCE TO RELATED APPLICATION

This application claims the benefit of Chinese Patent Application No. CN202211110533.6 filed on Sep. 13, 2022, in the State Intellectual Property Office of China, the whole disclosure of which is incorporated herein by reference.

### FIELD OF THE INVENTION

The present invention relates to an injection mold insert and a method for manufacturing the injection mold insert.

### BACKGROUND

An electrical connector typically consists of a conductive terminal and a plastic housing. The plastic housing is usually manufactured using injection molding technology, which utilizes an injection mold insert to form the plastic housing. The molding cycle of the injection molding process is crucial for the production efficiency of the connector housing. In the injection molding cycle, the cooling time often accounts for the majority of the entire molding cycle, sometimes even accounting for more than 50% of the molding cycle. Therefore, how to effectively reduce cooling time while ensuring product quality and production stability is critical for reducing the molding cycle.

According to the prior art, the injection mold insert is usually made of steel. In order to improve the cooling efficiency of injection mold insert, it is usually necessary to form a cooling channel, such as a water cooling channel, in the injection mold insert. However, for a connector housing with complex structure, it is often difficult to form cooling water paths that reach certain hot spot areas of injection mold insert, resulting in poor cooling effect in the hot spot areas, thereby affecting the quality and molding cycle of the connector housing. In addition, for relatively small connector housings, the hot spot areas do not provide enough space for permitting the formation of cooling channels, resulting in poor cooling effect in the hot spot area and reducing the injection molding cycle of the connector product.

### SUMMARY

According to an embodiment of the present disclosure, an injection mold insert includes a first metal structure and a second metal structure. The first metal structure has a first hardness and a first thermal conductivity. The second metal structure is wrapped in the first metal structure and has a second hardness less than that of the first hardness, and a second thermal conductivity higher than the first thermal conductivity. The first metal structure and the second metal structure are sintered together without layering or infiltration.

### BRIEF DESCRIPTION OF THE DRAWINGS

The invention will now be described by way of example with reference to the accompanying Figures, of which:

FIG. 1 is an illustrative view of using two laser printing heads to simultaneously print the first metal structure and the second metal structure according to an exemplary embodiment of the present invention, wherein the bottom portion of the first metal structure and the second metal structure have just been printed;

FIG. 2 is an illustrative view of using two laser printing heads to simultaneously print the first metal structure and the second metal structure according to an exemplary embodiment of the present invention, wherein a majority of the first metal structure and the second metal structure have been printed;

FIG. 3 is an illustrative view of using two laser printing heads to simultaneously print the first metal structure and the second metal structure according to an exemplary embodiment of the present invention, wherein the first metal structure and the second metal structure have been printed;

FIG. 4 is an illustrative view of the structure of a laser printing head according to an exemplary embodiment of the present invention;

FIG. 5 is an illustrative view of a second metal structure machined on a second metal block according to an exemplary embodiment of the present invention;

FIG. 6 is an illustrative view of a first metal structure printed on the second metal structure shown in FIG. 5 using a laser printing head according to an exemplary embodiment of the present invention, wherein a large portion of the first metal structure has been printed;

FIG. 7 is an illustrative view of a first metal structure printed on the second metal structure shown in FIG. 5 using a laser printing head according to an exemplary embodiment of the present invention, wherein the first metal structure has been printed;

FIG. 8 is an illustrative view of a first metal structure machined on a first metal block according to an exemplary embodiment of the present invention;

FIG. 9 is an illustrative view of using a laser printing head to print a second metal structure in the cavity of the first metal structure shown in FIG. 8, according to an exemplary embodiment of the present invention;

FIG. 10 is an illustrative view of the first metal structure manufactured according to an exemplary embodiment of the present invention;

FIG. 11 is an illustrative view of filling a second metal powder in the cavity of the first metal structure shown in FIG. 10, according to an exemplary embodiment of the present invention; and

FIG. 12 is an illustrative view of heating and melting the second metal powder shown in FIG. 11 according to an exemplary embodiment of the present invention.

### DETAILED DESCRIPTION OF THE EMBODIMENTS

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

According to an embodiment of the present disclosure, an injection mold insert includes a first metal structure, and a second metal structure which is wrapped in the first metal structure. The hardness of the first metal structure is higher than that of the second metal structure, and the thermal conductivity of the second metal structure is higher than that of the first metal structure. At least one of the first metal structure and the second metal structure is made by heating and molting metal powder, such that the first metal structure and the second metal structure are sintered together without layering or infiltration.

According to another embodiment, a method for manufacturing the above injection mold insert includes the steps of: providing a first laser printing head and a second laser printing head; and simultaneously printing the first metal structure and the second metal structure by using the first laser printing head and the second laser printing head, respectively. The first laser printing head ejects a first metal powder and emits a first laser beam, which heats and melts the ejected first metal powder to produce the first metal structure. The second laser printing head ejects a second metal powder and emits a second laser beam, which heats and melts the ejected second metal powder to produce the second metal structure.

According to another embodiment, a method for manufacturing the above injection mold insert includes the steps of: machining the first metal structure on a first metal block, wherein the first metal structure has a cavity complementary to the second metal structure; and printing the second metal structure in the cavity of the machined first metal structure by using a laser printing head. During printing the second metal structure, the laser printing head ejects a second metal powder and emits a laser beam, which heats and melts the ejected second metal powder to produce the second metal structure.

According to another embodiment, a method for manufacturing the above injection mold insert includes the steps of: machining the second metal structure on a second metal block; and printing the first metal structure on the machined second metal structure by using a laser printing head. During printing the first metal structure, the laser printing head ejects a first metal powder and emits a laser beam, which heats and melts the ejected first metal powder to produce the first metal structure.

According to another embodiment, a method for manufacturing the above injection mold insert includes the steps of: manufacturing the first metal structure, which has a cavity complementary to the second metal structure; filling the cavity of the first metal structure with a second metal powder; and heating and melting the second metal powder to produce the second metal structure.

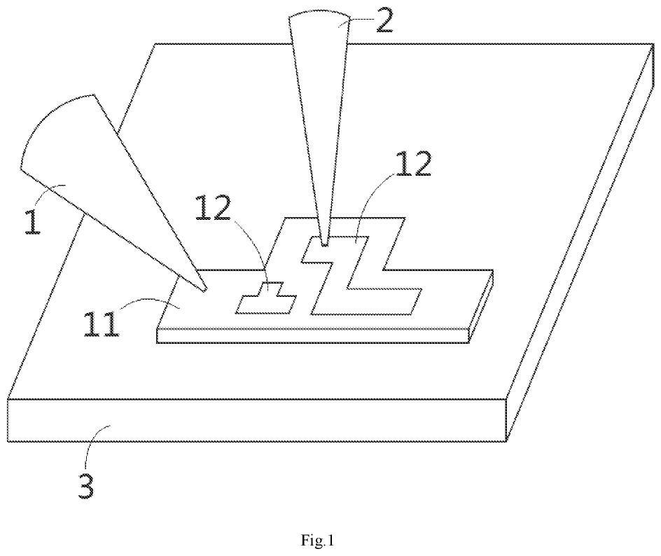

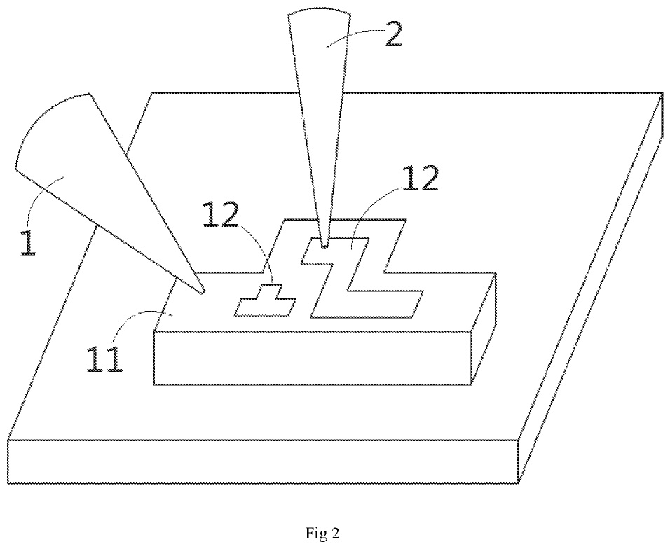

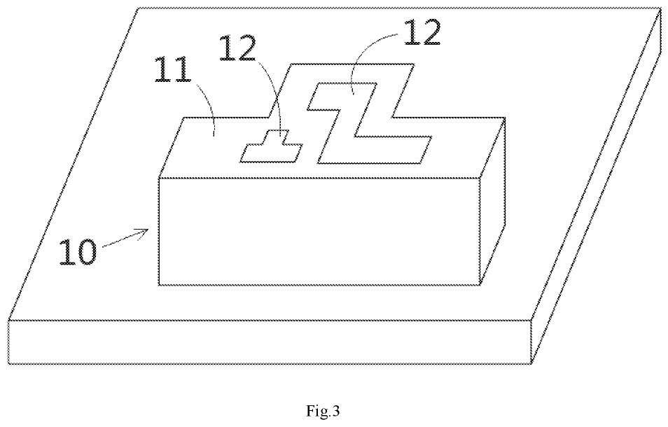

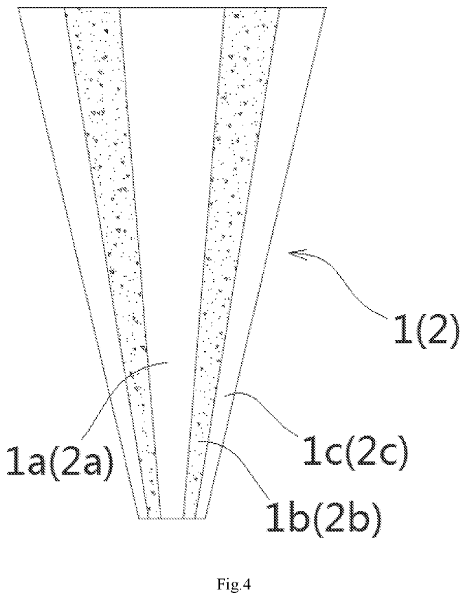

FIG. 1 is an illustrative view of using two laser printing heads 1, 2 to simultaneously print a first metal structure 11 and a second metal structure 12 according to an exemplary embodiment of the present invention, wherein the bottom parts of the first metal structure 11 and the second metal structure 12 have just been printed. FIG. 2 is an illustrative view of using the two laser printing heads 1, 2 to simultaneously print the first metal structure 11 and the second metal structure 12 according to an exemplary embodiment of the present invention, wherein a large portion of the first metal structure and the second metal structure have been printed. FIG. 3 is an illustrative view of using two laser printing heads 1, 2 to simultaneously print the first metal structure 11 and the second metal structure 12 according to an exemplary embodiment of the present invention, wherein the first metal structure and the second metal structure have been printed. FIG. 4 is an illustrative view of the structure of laser printing heads 1, 2 according to an exemplary embodiment of the present invention.

As shown in FIGS. 1-4, in an exemplary embodiment of the present invention, a method for manufacturing an injection mold insert 10 is disclosed. The method for manufacturing the injection mold insert 10 mainly includes the following steps of:
S11: providing the first laser printing head 1 and the second laser printing head 2; and
S12: using the first laser printing head 1 and the second laser printing head 2 to simultaneously and respectively print the first metal structure 11 and the second metal structure 12 on the substrate 3.

During printing, the first laser printing head 1 ejects a first metal powder and emits a first laser beam. The first laser beam heats and melts the ejected first metal powder to produce the first metal structure 11. Likewise, during printing, the second laser printing head 2 ejects a second metal powder and emits a second laser beam, which heats and melts the ejected second metal powder to form the second metal structure 12. During printing, the first laser printing head 1 also ejects a first inert gas to prevent oxidation of the molten first metal powder, and the second laser printing head 2 also ejects a second inert gas to prevent oxidation of the molten second metal powder.

The first laser printing head 1 includes: a first laser beam channel 1a, a first metal powder channel 1b, and a first inert gas channel 1c. The first laser beam channel 1a is located at the center of the first laser printing head 1, and the first laser beam is emitted through the first laser beam channel. The first metal powder channel 1b surrounds the first laser beam channel 1a, and the first metal powder is ejected from the outlet of the first metal powder channel. The first inert gas channel 1c surrounds the first metal powder channel 1b, and the first inert gas is ejected from the outlet of the first inert gas channel.

In the illustrated embodiment, the second laser printing head 2 includes: a second laser beam channel 2a, a second metal powder channel 2b, and a second inert gas channel 2c. The second laser beam channel 2a is located at the center of the second laser printing head 2, and the second laser beam is emitted through the second laser beam channel. The second metal powder channel 2b surrounds the second laser beam channel 2a, and the second metal powder is ejected from the outlet of the second metal powder channel. The second inert gas channel 2c surrounds the second metal powder channel 2b, and the second inert gas is ejected from the outlet of the second inert gas channel.

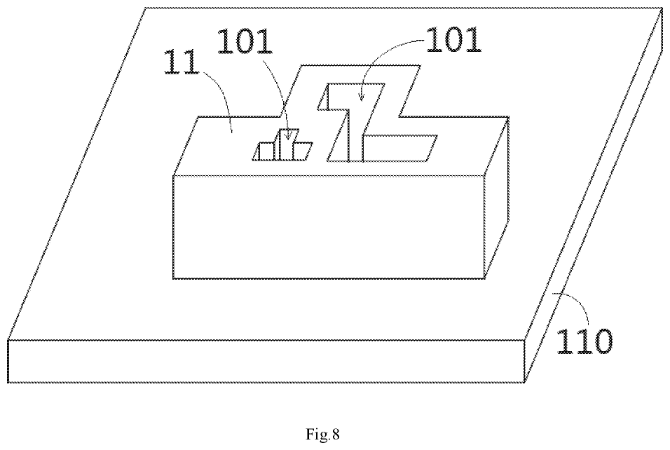

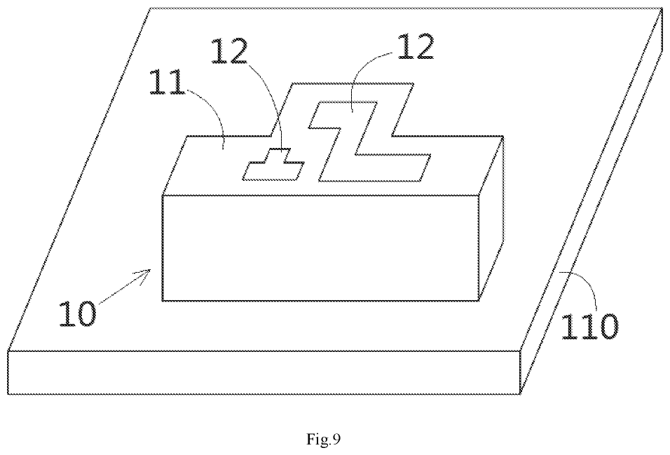

FIG. 8 is an illustrative view of the first metal structure 11 machined on the first metal block 110 according to an exemplary embodiment of the present invention. FIG. 9 is an illustrative view of a second metal structure 12 printed in the cavity 101 of the first metal structure 11 shown in FIG. 8 using a laser printing head (see laser printing head 2 in FIGS. 1-4) according to an exemplary embodiment of the present invention.

As shown in FIGS. 8 and 9, in another exemplary embodiment of the present invention, a method for manufacturing an injection mold insert 10 is also disclosed. The method for manufacturing the injection mold insert 10 mainly includes the following steps:
S21: as shown in FIG. 8, a first metal structure 11 is machined on the first metal block 110, and has a cavity 101 complementary to the second metal structure 12; and
S22: as shown in FIG. 9, the second metal structure 12 is printed using a laser printing head in the cavity 101 of the machined first metal structure 11.

When printing the second metal structure 12, the laser printing head ejects the second metal powder and emits a laser beam. The laser beam heats and melts the ejected second metal powder to produce the second metal structure 12. After printing the second metal structure 12, the injection mold insert 10 produced is cut off from the first metal block 110 and subjected to corresponding subsequent treatments, such as polishing and heat treatment.

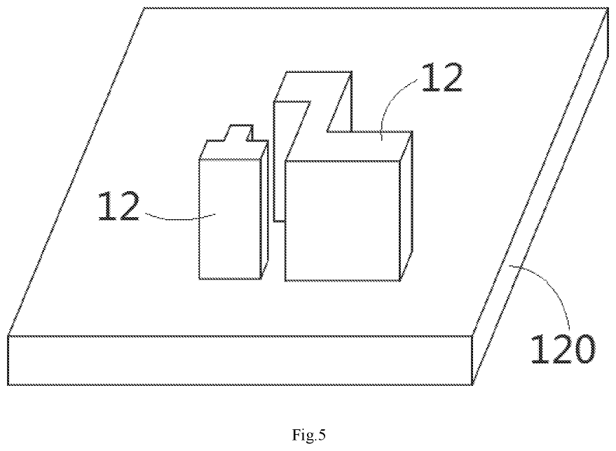

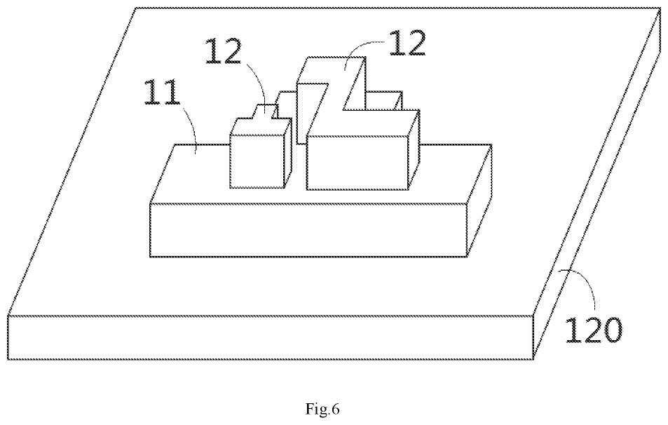

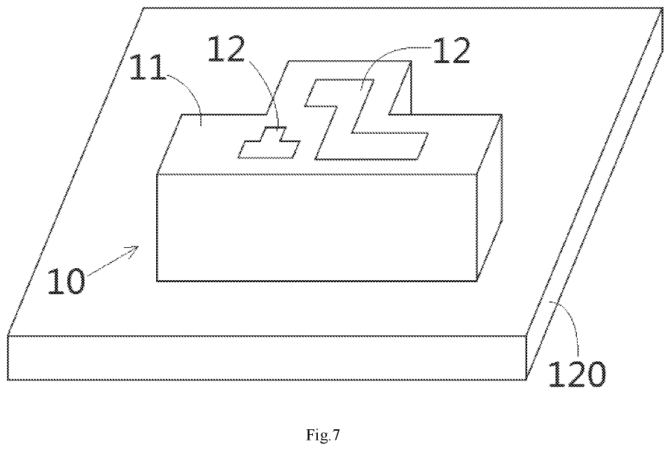

FIG. 5 is an illustrative view of a second metal structure 12 machined on a second metal block 120 according to an exemplary embodiment of the present invention. FIG. 6 is an illustrative view of the first metal structure 11 printed on the second metal structure 12 shown in FIG. 5 using a laser printing head (see laser printing head 1 in FIGS. 1-4) according to an exemplary embodiment of the present invention, where a large portion of the first metal structure 11 has been printed. FIG. 7 is an illustrative view of using a laser printing head to print the first metal structure 11 on the second metal structure 12 shown in FIG. 5, according to an exemplary embodiment of the present invention, where the first metal structure 11 has been printed. As shown in FIGS. 5-7, in another exemplary embodiment of the present invention, a method for manufacturing an injection mold insert 10 is also disclosed. The method for manufacturing the injection mold insert 10 includes the following steps:
S31: as shown in FIG. 5, the second metal structure 12 is machined on the second metal block 120; and
S32: as shown in FIGS. 6 and 7, the first metal structure 11 is printed on the machined second metal structure 12 using a laser printing head.

In the illustrated embodiments, when printing the first metal structure 11, the laser printing head ejects the first metal powder and emits a laser beam. The laser beam heats and melts the ejected first metal powder to produce the first metal structure 11. After printing the first metal structure 11, the manufactured injection mold insert 10 is cut off from the second metal block 120 and subjected to corresponding subsequent treatments, such as polishing and heat treatment.

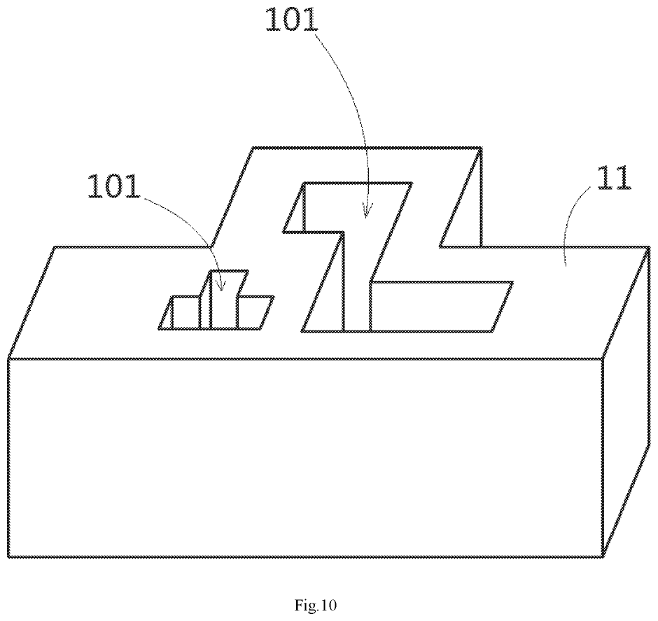

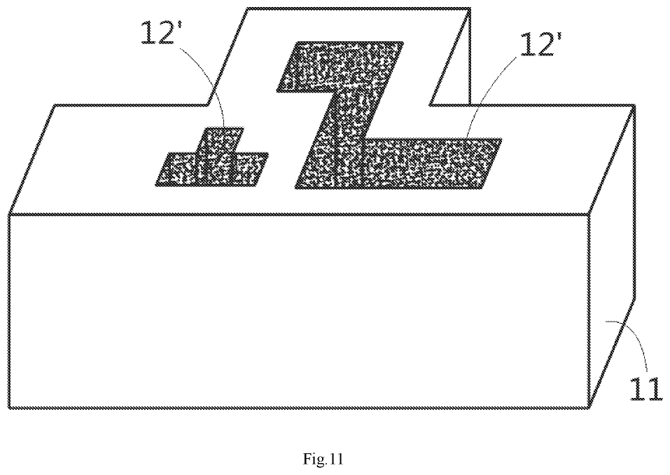

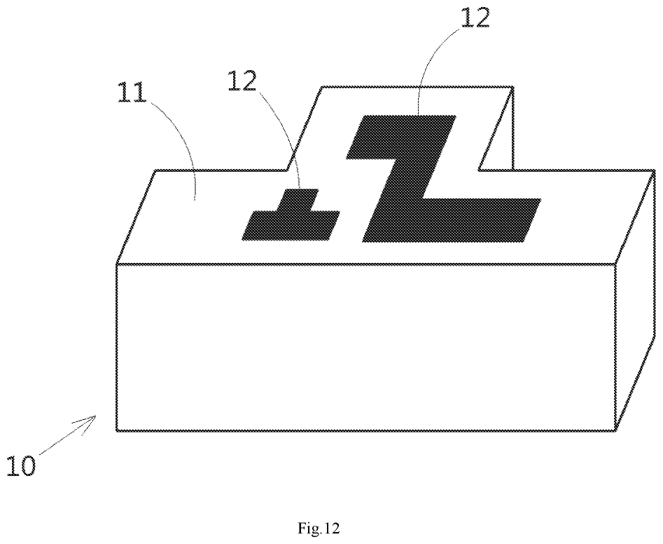

FIG. 10 is an illustrative view of the first metal structure 11 manufactured according to an exemplary embodiment of the present invention. FIG. 11 is an illustrative view of filling a second metal powder 12′ in the cavity 101 of the first metal structure 11 shown in FIG. 10, according to an exemplary embodiment of the present invention. FIG. 12 is an illustrative view of heating and melting the second metal powder 12′ shown in FIG. 11 according to an exemplary embodiment of the present invention. As shown in FIGS. 10-12, in another exemplary embodiment of the present invention, a method for manufacturing an injection mold insert 10 is also disclosed. The method for manufacturing the injection mold insert 10 includes the following steps:
S41: manufacturing the first metal structure 11, which has a cavity 101 complementary to the second metal structure 12;
S42: filling the cavity 101 of the first metal structure 11 with the second metal powder 12′; and
S43: heating the second metal powder 12′ to melt it to form the second metal structure 12.

In the illustrated embodiments, in step S41, the first metal structure 11 may be manufactured by machining or printing.

In the present invention, the aforementioned printing method may include the use of laser 3D printing.

Referring generally to FIGS. 1-12, in another exemplary embodiment of the present invention, an injection mold insert 10 is also disclosed which includes the first metal structure 11 and the second metal structure 12. The second metal structure 12 is wrapped in the first metal structure 11. The hardness of the first metal structure 11 is higher than that of the second metal structure 12, and the thermal conductivity of the second metal structure 12 is higher than that of the first metal structure 11. At least one of the first metal structure 11 and the second metal structure 12 is made by heating and melting metal powder, so that the first metal structure and the second metal structure are sintered together with each other without layering or infiltration.

In one embodiment, the first metal structure 11 is a steel structure or steel alloy structure, and the second metal structure 12 is a copper structure or copper alloy structure. Therefore, the aforementioned metal powder can be copper powder, copper alloy powder, steel powder, or steel alloy powder. Further, in the illustrated embodiments, the second metal structure 12 includes at least one irregularly shaped complex structure. A maximum cross-sectional size of the aforementioned complex structure is less than 4 mm, 3 mm, 2 mm, or 1 mm. In an exemplary embodiment of the present invention, the first metal structure 11 and the second metal structure 12 may each include multiple layers, and the multiple layers of the first metal structure 11 and the multiple layers of the second metal structure 12 are arranged alternately in a stacked manner.

In addition, those areas in which it is believed that those of ordinary skill in the art are familiar, have not been described herein in order not to unnecessarily obscure the invention described. Accordingly, it has to be understood that the invention is not to be limited by the specific illustrative embodiments, but only by the scope of the appended claims.

It should be appreciated for those skilled in this art that the above embodiments are intended to be illustrated, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of the elements or steps, unless such exclusion is explicitly stated. Furthermore, references to “one embodiment” of the present disclosure are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

What is claimed is:

1. An injection mold insert, comprising:
a first metal structure having a first hardness and a first thermal conductivity; and
a second metal structure wrapped in the first metal structure and having a second hardness less than that of the first hardness, and a second thermal conductivity higher than the first thermal conductivity, the first metal structure and the second metal structure are sintered together without layering or infiltration.

2. The injection mold insert according to claim 1, wherein at least one of the first metal structure or the second metal structure is formed by heating and molting metal powder.

3. The injection mold insert according to claim 1, wherein the first metal structure is a steel structure or steel alloy structure, and the second metal structure is a copper structure or copper alloy structure.

4. The injection mold insert according to claim 1, wherein the second metal structure comprises at least one irregularly shaped complex structural body.

5. The injection mold insert according to claim 1, wherein the maximum cross-sectional size of the complex structure is less than 4 mm.

6. The injection mold insert according to claim 1, wherein the first metal structure and the second metal structure respectively include multiple layers, the multiple layers of the first metal structure and the multiple layers of the second metal structure are alternately stacked.

7. A method for manufacturing an injection mold insert comprising the steps of:
forming a first metal structure having a first hardness and a first thermal conductivity; and
forming a second metal structure wrapped in the first metal structure and having a second hardness less than that of the first hardness, and a second thermal conductivity higher than the first thermal conductivity, wherein the formation of at least one of the first metal structure or the second metal structure sintering the first metal structure and the second metal structure together without layering or infiltration.

8. The method according to claim 7, wherein the steps of forming the first and second metal structures include simultaneously printing the first metal structure and the second metal structure using a first laser printing head and a second laser printing head, respectively.

9. The method according to claim 8, wherein the first laser printing head ejects a first metal powder and emits a first laser beam heating and melting the ejected first metal powder to produce the first metal structure.

10. The method according to claim 9, wherein the second laser printing head ejects a second metal powder and emits a second laser beam heating and melting the ejected second metal powder to produce the second metal structure.

11. The method according to claim 10, wherein at least one of:
the first laser printing head also ejects a first inert gas to prevent oxidation of the molten first metal powder during printing; or
the second laser printing head also ejects a second inert gas to prevent oxidation of the molten second metal powder during printing.

12. The method according to claim 11, wherein the first laser printing head comprises:
a first laser beam channel located at the center of the first laser printing head, wherein the first laser beam is emitted through the first laser beam channel;
a first metal powder channel surrounds the first laser beam channel, wherein the first metal powder is ejected from an outlet of the first metal powder channel; and
a first inert gas channel surrounds the first metal powder channel, wherein the first inert gas is ejected from an outlet of the first inert gas channel.

13. The method according to claim 12, wherein the second laser printing head comprises:
a second laser beam channel located at the center of the second laser printing head, wherein the second laser beam is emitted through the second laser beam channel;
a second metal powder channel surrounds the second laser beam channel, wherein the second metal powder is ejected from an outlet of the second metal powder channel; and
a second inert gas channel surrounds the second metal powder channel, wherein the second inert gas is ejected from an outlet of the second inert gas channel.

14. The method according to claim 7, wherein:
the step of forming the first metal structure includes machining the first metal structure on a first metal block, wherein the first metal structure has a cavity complementary to the second metal structure; and
the step of forming the second metal structure includes printing the second metal structure in the cavity of the machined first metal structure by using a laser printing head, wherein during printing the second metal structure, the laser printing head ejects a second metal powder and emits a laser beam, which heats and melts the ejected second metal powder to produce the second metal structure.

15. The method according to claim 14, further comprising a step of cutting the manufactured injection mold insert from the first metal block.

16. The method according to claim 7, wherein:
the step of forming the second metal structure includes machining the second metal structure on a second metal block; and
the step of forming the first metal structure includes printing the first metal structure on the machined second metal structure by using a laser printing head, wherein during printing the first metal structure, the laser printing head ejects a first metal powder and emits a laser beam, which heats and melts the ejected first metal powder to produce the first metal structure.

17. The method according to claim 16, further comprising a step of cutting the manufactured injection mold insert from the second metal block.

18. The method according to claim 7, wherein:
the step of forming the first metal structure includes manufacturing the first metal structure to have a cavity complementary to the second metal structure; and
the step of forming the second metal structure includes filling the cavity of the first metal structure with a second metal powder.

19. The method of claim 18, wherein the step of forming the second metal structure further includes heating and melting the second metal powder to produce the second metal structure.

20. The method according to claim 18, wherein the step of manufacturing the first metal structure includes machining or printing the first metal structure.
